(19) United States
(12) Patent Application Publication
(10) Pub. No.: US 2004/0194540 A1
(43) Pub. Date: Oct. 7, 2004

(54) Method and device for monitoring the dispersibility of solid formulations

(76) Inventor: Klaus Wangermann, Krefeld (DE)

Correspondence Address: BAYER CROPSCIENCE LP, Patent Department, 100 BAYER ROAD, PITTSBURGH, PA, 15205-9741, US

(21) Appl. No.: 10/404,455

(22) Filed: Apr. 1, 2003

(51) Int. Cl. G01N 15/04

(52) U.S. Cl. 73/61.63

(57) ABSTRACT

The invention relates to a device and a method for monitoring the dispersibility of solid formulations. The single-measurement method involves measuring the course of the dispersibility of a sample in a fluid over time. The build-up measurement method involves detecting hard particles in a dispersion. The device according to the invention is equipped with a pump, a flow meter, a charging receptacle for the sample, and a filter element, all of which are connected to each other via a fluid circuit, wherein the filter element is arranged downstream behind the charging receptacle with respect to the direction of flow as predetermined by the pump.

### BACKGROUND OF THE INVENTION

The invention relates to a method and device for monitoring the dispersibility of solid formulations.

The formulation type “water-dispersible granules” is used frequently for crop protection products in agricultural practice. Using formulation auxiliaries, stickers, and suitable granulating apparatuses, primary particles in a size ranging from approximately one to over ten micrometers are used to build up granules that, in turn, have dimensions of a few hundred micrometers up to a few millimeters. On the one hand, such granules must be abrasion resistant and resistant to breaking; on the other hand, they must disperse rapidly and completely into the primary particles when introduced into water. This aim is difficult to achieve since, in general, an improved abrasion resistance and resistance to breaking diminishes dispersibility and vice versa.

Complete dispersing, which is desired, means that the granules, when introduced into water or another fluid, disintegrate into the primary particles. If disintegration is incomplete, what are known as hard particles remain in the dispersion, and these hard particles may cause clogging-up of the filters. Hard particles may be, for example, particles of active compound that, due to being exposed to high temperatures after their production, have baked together, or else are insufficiently ground components of the formulation, in which case they already exist when the granules are being produced and are incorporated therein. The size of hard particles may range from a few tens to several hundred micrometers; they are characterized by being retained on a filter with a suitable mesh size and can pass through this filter only when an elevated pressure is applied or not at all.

When the products are used in practice, incomplete dispersion is immediately discernible and can lead to the clogging of filters in the spray tank of a field sprayer and adversely affect the biological activity. This is why the product characteristic of dispersibility must be monitored continuously during the development and production of granules. Rapid and complete dispersing is an important quality characteristic not only of granules but also of other solid formulations that are dispersed in fluids, including those used in fields other than agriculture.

Methods known for assessing the dispersibility of crop protection products are, for example, internationally “standardized” methods. See CIPAC Handbook, Volume 1, pp. 860-868 (“Analysis of Technical and Formulated Pesticides,” compiled by R. de B. Ashworth, J. Henriet, and J. F. Lovett; Edited by G. R. Raw Herfordshire England 1970) and later editions, for example, Volume F, pp.416-419. This handbook describes the method CIPAC MT 15 (“Suspensibility of water dispersible powders”), by means of which the quality of water-dispersible powders is determined in a simple glass cylinder test. This MT 15 is supplemented by the method CIPAC MT 168 (“Determination of the suspension stability of water dispersible granules”), which agrees with MT 15 except for details but refers to granules. According to this method, a 250 ml glass cylinder is filled with water, the granules are added, and the cylinder is sealed. The cylinder is then turned repeatedly by 180 degrees so that the granules are mixed with the water and can disintegrate during this process. For granules that are readily dispersible in water, a suspension is obtained. This suspension, which is homogeneous at the outset, is left to stand for 30 minutes, during which time the solid particles (which as a rule have a density of more than 1 g/cm³) settle in the water (density 1 g/cm³) due to the effect of gravity. After 30 minutes, the top 9/10 of the suspension are removed, and the amount of material that has accumulated in the remaining bottom 1/10 is determined. If the suspension were completely stable, this would be just as much as at the beginning of the experiment, namely exactly 1/10 (i.e., 10%). However, in real suspensions, the particles fall to the bottom and more than 10% sediment is observed. As far as product quality is concerned, the higher the sedimentation layer determined, the worse the product quality. The test is designed in such a way that all particles whose size exceeds approximately 10 μm, but only a certain fraction of the smaller particles, contribute to the sediment. The test result is a figure that is useful for comparison purposes but has no direct equivalent under realistic conditions; it gives some information on how much sediment would form if the batch were left to stand, for example, overnight. Thus, no information is gained on the dynamics of granule disintegration, which is very important under realistic conditions. Moreover, no information on the risk of clogging up the filter is obtained in this test, since the “critical particle size”, which determines the result, is approximately 10 μm in this test whereas the filters in field sprayers have a mesh size of at least 150 μm. Thus, a high sedimentation value does not necessarily indicate that clogged filters are unavoidable; that is to say, the test result may be misleading in this respect.

In what is known as the “DuPont method” (Thomas Cosgrove, DuPont Agricultural Enterprise, Stine-Haskell Research Center, 1090 Elkton Road, Newark, Del. 19711-3507, U.S.A.; Revised method for break up time of WGs (CIPAC/4185/R)), a small cylindrical basket for which the walls and bottom consist of a mesh of 150 μm mesh size is filled with granules. This basket is immersed into a glass beaker containing water and moved up and down in the water. During this process, readily water-dispersible granules can disintegrate and the fragments pass outwardly from the inside of the basket through the mesh. After a predetermined time has elapsed, any residue that may be present in the basket is collected, dried, and weighed, and this residue is compared with the original weight. In this test, the dynamics of disintegration are taken into consideration to some extent insofar as the movement of the basket in the water somewhat resembles the conditions in a field sprayer. In a field sprayer, however, disintegration takes place in a much faster flow that is generated by a powerful pump, meaning that the forces or shear stresses encountered in a field sprayer are quite different. While the screen mesh size in this test more accurately reflects realistic conditions than CIPAC MT 168, it cannot be modified. Again, the result is a single figure that has no direct equivalent under realistic conditions.

These known tests address only some aspects of product quality and take into consideration the important dynamic dispersing processes when the product is introduced into the spray tank of a field sprayer in a too one-sided manner, or not at all, or not in a manner that is relevant to realistic conditions.

In principle, it is possible, of course, to assess the dispersing behavior of a solid formulation in a test using a field sprayer such as is used by the agricultural practitioner for the spray application of crop protection products. However, such a test is very complicated and expensive. Up to 30 kg of product are required, and up to 3000 liters of waste water must be disposed of, so that such realistic tests are not suitable ether for the development of products or for monitoring production. Likewise, technical reasons do not allow such a laboratory test to be scaled down and to be set up, for example, as a scaled down field sprayer.

It is therefore the object of the invention to simulate the dispersibility of solid formulations in the laboratory under conditions that require as little sample material, water, waste water, and time as possible.

In the following text, samples are understood as meaning solid formulations of active compounds, particularly granules that consist of primary particles and that, in addition to the active compound, generally also contain adjuvants such as inert fillers, stickers, and dispersants.

### SUMMARY OF THE INVENTION

The object of the invention is achieved by two methods according to the invention, which can be applied to a sample individually or in succession. These methods monitor the two essential aspects on dispersibility that contribute to the quality of a sample during application, namely the disintegration rate in a fluid (which is monitored by the first method according to the invention) and the completeness of disintegration to avoid the clogging-up of filters (which is monitored by the second method according to the invention).

The first method according to the invention, referred to as the single measurement, consists of measuring the course of the dispersibility of a sample in a fluid over time. It includes the steps in which

(a) the fluid is circulated through a sample charging receptacle, a filter element that is arranged downstream of the charging receptacle with respect to the direction of flow determined by the pump, and a flow meter,

(b) the flow through the flow meter is measured in the course of time during and after the charging receptacle is being or has been charged with the sample, and

(c) characteristic features of the flow rate vs. time are evaluated.

The second method according to the invention, in what is known as the build-up measurement, consists in the detection of hard particles in a dispersion, where

(a) a fluid is circulated through a sample charging receptacle, a filter element that is arranged downstream of the charging receptacle with respect to the direction of flow determined by the pump, and a flow meter,

(b) the flow through the flow meter is measured over a predetermined period of time during and after a sample is being or has been charged to the charging receptacle,

(c) the suspension is drawn off from the circulation and fresh fluid is fed in, without removing any deposit that may be present on the filter,

(d) steps (b) and (c) are repeated several times with more of the same samples, and (e) characteristic features of the flow rate vs. time plot are evaluated.

The object according to the invention is furthermore achieved by a device for carrying out the methods according to the invention.

### BRIEF DESCRIPTION OF THE DRAWINGS

FIG. 1 shows the schematic shape of a test curve in a single measurement.

FIG. 2 shows the schematic shape of a test curve in a build-up measurement.

FIG. 3 shows a design example of the device according to the invention.

FIG. 4 shows a filter element.

FIG. 5 shows a test curve of a single measurement on water-dispersible granules containing 70% by weight active ingredient.

FIG. 6 shows a test curve of a five-step build-up measurement.

FIGS. 7a, 7b, and 7c show build-up measurements of samples with progressively higher contents of hard particles.

FIG. 8a shows a single measurement. FIGS. 8b, 8c, 8d, and 8e show build-up measurements of various weights of a sample.

FIG. 9 shows a build-up measurement for sample 1,

FIG. 10 shows a single measurement for sample 2,

FIG. 11 shows a single measurement for sample 3, and

FIGS. 12 and 13 show single measurements for sample 4.

### DETAILED DESCRIPTION OF THE INVENTION

In the first method of the invention, the sample is charged to the charging receptacle in such a way that the sample is rapidly and uniformly distributed in water and, after a few seconds, reaches the filter element, where it is stopped abruptly at the filter mesh and concentrated in the event that disintegration has not taken place yet. The measuring effect is brought about by continuously measuring the flow rate of the fluid through the filter element before, during, and after sample introduction and recording it versus time. The flow rate is initially 100% and is first reduced as the sample builds up on the filter element. Depending on the disintegration rate of the sample, the flow rate will eventually go up again. The duration of this process, and the extent to which the flow rate has previously dropped towards zero, characterize the sample quality and are expressed in suitable characteristics as discussed below.

Due to the accurate setting and monitoring of the temperature of the fluid, sample concentration, the mesh size of the filter and the water quality, each single measurement proceeds in a defined manner, whereby highly reproducible data are obtained. When crop protection granules are studied, the temperature of the fluid is preferably in the range of from 5° C. to 30° C. The concentration of the suspension (weight ratio of sample to fluid) is preferably in the range of from 0.05% to 5%, especially preferably in the range of from 0.1 to 1.0%. The mesh size of the filter is preferably in the range of from 50 μm to 1000 μm, especially preferably in the range of from 150 μm to 500 μm. Water quality, particularly hardness, has only a weak effect on measuring the dispersibility in water, which is why it can be chosen freely, but is preferably in the range of from 342 to 500 ppm as specified in CIPAC MT 18 (CIPAC Handbook) for comparison reasons.

Characteristic measurements of the flow rate vs. time plot for a single measurement are peak depth, peak width, peak area, and any deviation of the plot from the 100% line at the end of the measuring interval. The peak depth indicates the permeability retained by the filter deposit, or whether the flow rate is reduced to zero in extreme cases.

The peak width indicates the residence time of the sample on the filter element before the sample has eroded to the extent that it is capable of passing through the filter element. The peak area indicates the amount of energy (suction power of the pump×time) required for eroding the sample, or how much “resistance” is met. The deviation of the plot from the 100% line of the flow rate at the end of the measuring interval indicates a permanent reduction of the flow rate, for example, when hard particles have become deposited on the filter. All these parameters change systematically when the sample quantity used for the experiment is altered. This fact can be exploited for optimizing the measuring conditions.

The single measurement characterizes the phase of pouring the product into the spray tank of a field sprayer up to the point at which the granules reach the first filter, for example, the suction filter. If the granules are not readily dispersible in water, this is where they can accumulate for a long time and clog the filter. As a consequence, the pump may be damaged since the flow is hindered.

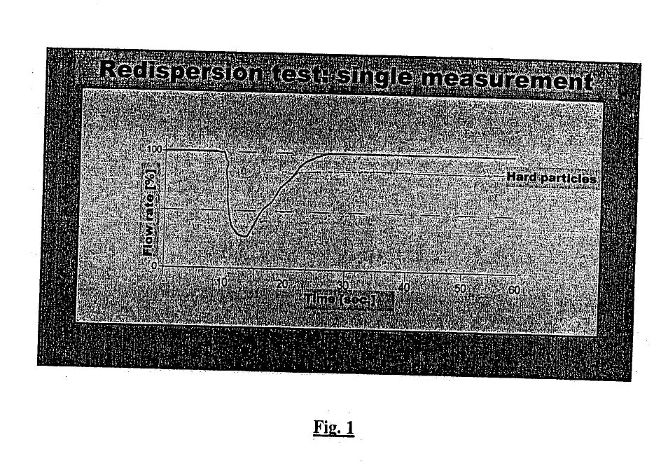

FIG. 1 shows the schematic course of a plot of a single measurement. The plot starts at a flow rate value of 100%. Shortly after introducing the sample, the reading drops to a minimum and, in the present case of a readily dispersible sample, soon returns to 100% (solid curve in FIG. 1) because all solid particles are capable of passing through the filter.

A permanent deviation is observed only when the sample contains hard particles (dotted line in FIG. 1). The hard particle content can be determined in this case by means of a build-up measurement, which records even minute deviations.

Several cases, each of which leads to characteristic curves in the single measurement, can be distinguished:

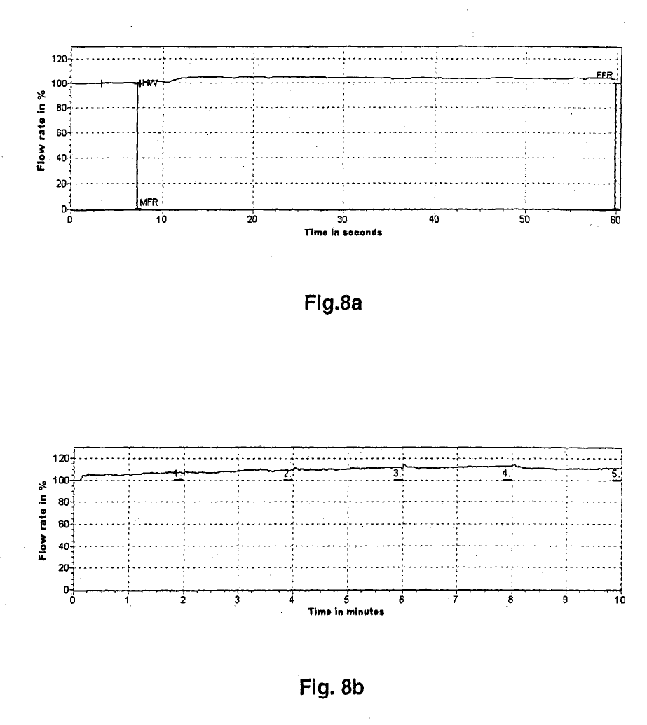

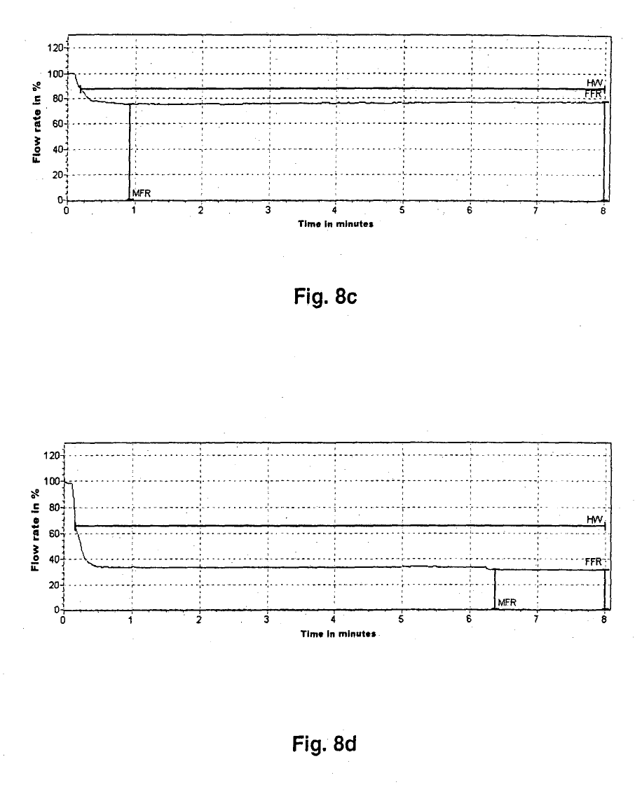

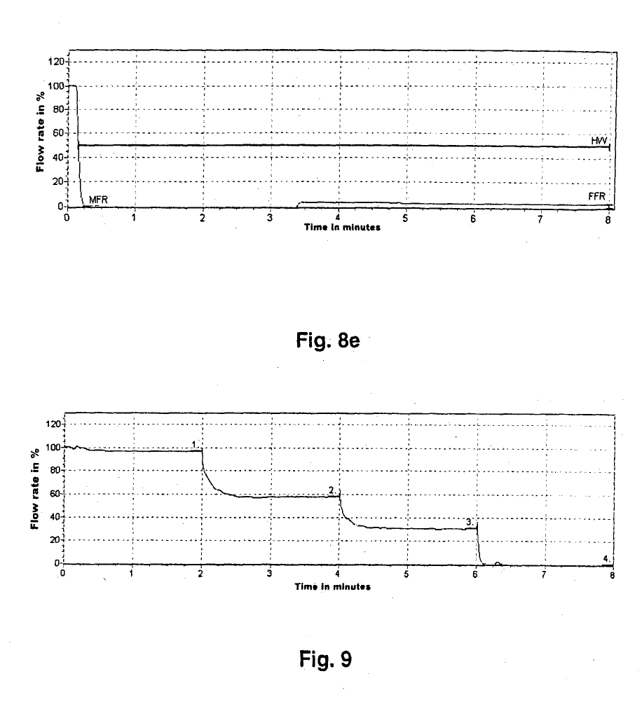

a) The samples have already disintegrated, or are smaller than the selected mesh size of the filter, before they reach the filter element. In this case, the flow rate after introduction of the sample is reduced to a negligible extent only or to nothing at all. In this case only a very small peak is measured, or none at all. Such a test curve is shown in FIG. 8a. Some spray-dried granules show this type of behavior. Spray-dried granules are frequently very small in size and they are therefore capable of passing freely through filters with a large mesh size. However, they would likewise accumulate on filters with a smaller filter mesh size, and a peak would result from the measurement. In such samples, the reading can depend greatly on the filter mesh size chosen.

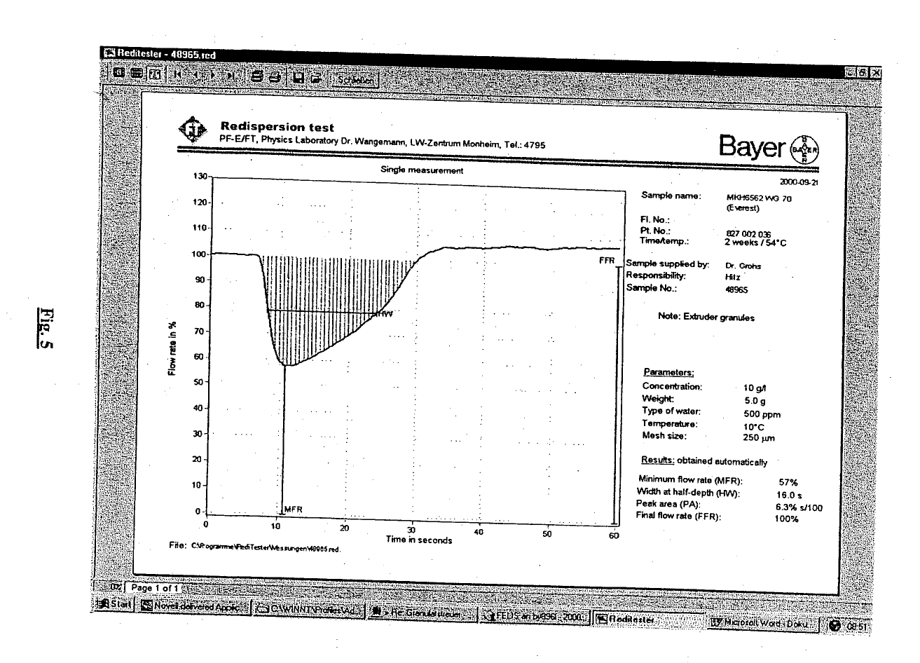

b) The samples accumulate on the filter but are eroded rapidly down to a size smaller than the filter mesh size. In this case, the reading will drop for a few seconds, but not necessarily down to 0%, and again reach 100% in less than 1 minute. Such an original test curve is shown in FIG. 5.

c) The samples only swell but initially form a compact layer that is more or less impervious to water. In this case a large and broad peak results. The flow rate drops rapidly to zero but increases again after some time, in some cases only after a few minutes have elapsed, and finally returns to the initial value of 100%. Such a test curve is shown in FIG. 13.

d) Due to a high hard-particle content, the samples disintegrate incompletely or not at all. In this case, a very deep, very broad peak results, and the flow rate does not return to 100% at the end of the measurement period but is permanently at a low level or indeed zero. Such a test curve is shown in FIG. 8e.

The shape of the curve depends characteristically on the formula and the manufacturing process of the solid formulation and also on later effects on the product during storage. This is why the shape of the curve allows conclusions to be drawn regarding possible reasons for a change in quality during production or storage, for example, due to the effect of temperature, pressure, humidity, and any chemical reactions that may occur.

In the second method according to the invention, the build-up measurement is a multiple (preferably a 1- to 20-fold, especially preferably a 5- to 10-fold) repetition of a single measurement with the corresponding multiple of sample but without intermediate cleaning of the filter element. When carrying out a build-up measurement, both the concentration of the sample in the water and the filter mesh size should be adapted to the measuring task since the result may otherwise be grossly distorted. Only hard particles for which the dimensions exceed the filter mesh size will become deposited on the filter. If, for example, hard particles of a very particular size are present, reducing the filter mesh size may lead to a measuring effect, whereas an enlargement will allow the hard particles to pass through and no measuring effect is obtained.

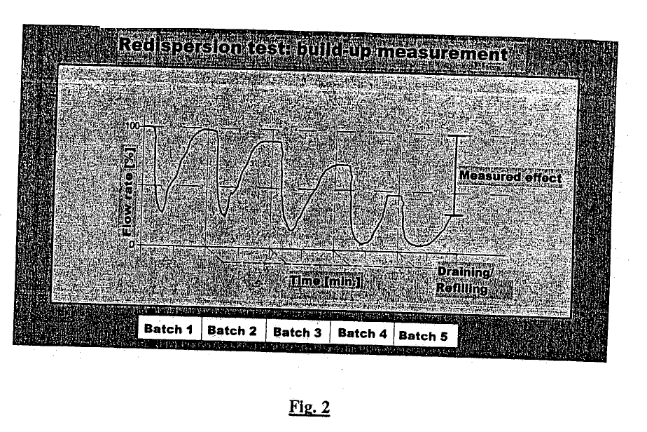

The measuring time for a build-up measurement is set to a fixed duration of 0.5 to 5 minutes (preferably 1 to 3 minutes) per measuring period. After this time has elapsed, the suspension is drawn off but in such a way that any filter deposit that may be present is retained and its structure left undisturbed. The system is then filled with new fluid, and the second portion of the sample is added to this second batch. Each individual batch is prepared with the same concentration, the same fluid temperature, the same pumping capacity, and, if appropriate, the same water quality. FIG. 2 shows the schematic course of the test curve of a build-up measurement with a total of 5 batches. The sample has a certain content of hard particles. The stepwise decrease of the test curve with each new batch is characteristic. The flow value at the end of each measuring period is evaluated as the characteristic reading. In the second measuring method according to the invention, the shape of the peak curves are immaterial, with only the increasing, permanent deposit on the filter caused by hard particles (i.e., the stepwise decrease of the test curve at the end of each measuring period) being decisive.

The build-up measurement reflects the phase of spraying a formulation that is already dispersed in the spray tank and where the suspension must pass through further filters such as a pressure filter and nozzle filters for which the filter mesh size is frequently small. The build-up measurement allows the amount of sample required for completely blocking these filters to be determined. Here, the disintegration dynamics identified in the first method according to the invention are immaterial.

The build-up measurement is very sensitive to relatively small amounts of hard particles and is capable of detecting such impurities in the sample, even in low percentages. This is achieved by feeding, in succession, several portions of the same sample, which accordingly contain more hard particles on average than for a single sample. The measuring procedure is similar to that of repeated spraying using a field sprayer that is not cleaned after each batch. Again and again, it is filled with new fluid and a new portion of sample, so that the deposit on the filter slowly increases in thickness, while the concentration of the sample in the fluid remains low for practical requirements. Since the filter element is not cleaned in between uses, even very low contents of hard particles in the sample can build up into a massive filter deposit that can be readily detected.

Thus, it is the aim of the build-up measurement to increase the deposit, which frequently amounts to little in a single measurement, by repetition, thereby facilitating its measurement. Using a simple formula, it is possible to extrapolate when filters with a larger surface in an original apparatus, for example, an agricultural field sprayer, would show the same sort of deposit. To this end, the size of the filtering surface in the corresponding original apparatus is first determined, and the ratio of the filtering surface of the original apparatus to the filtering surface used in the build-up measurement is calculated. This ratio is referred to as “surface ratio.”

The average flow reduction (AFR) is calculated from the means of the differences between the flow values at the end of each measuring period:

$$AFR = \frac{\begin{matrix}Mean of the differences in flow \\ reduction per measuring period [ \% ]\end{matrix}}{Sample weight [ g ]} [ \% / g ] .$$

Only in an ideal case, namely if the hard particles were distributed uniformly in the sample, would the steps in the individual measuring periods be equal in size. This is why the mean is calculated for the AFR. Moreover, the AFR is standardized for the sample weight. To calculate the AFR characteristic, it is assumed that the hard particles are distributed uniformly (homogeneously) in the sample, namely in such a way that each sample portion contains an equal amount. Even though this is not always the case, calculating the mean makes sense since a blocking layer is also formed when fewer hard particles are deposited in some cases, whereas more hard particles are deposited in other cases, the individual step being of no importance and only the amount deposited in total being meaningful.

When the content in the sample is generally very low, only a small step results per measuring period. This small effect can be increased by increasing the sample weight, which, however, results in an increased concentration of the sample in the fluid. In most cases, this has no adverse effect but considerably increases the measuring accuracy when effects are very small. An AFR of 1 means that for each g of sample portion per measuring period, the flow rate drops by 1% in each measuring period. In order to increase this measuring effect, the quantity might be increased to, for example, 5 g. For every 5 g of sample per measuring period, the flow rate in such a case would drop by 5% in each measuring period.

Thus, different sample weights result in the same AFR value but in different degrees of measuring effects. In an individual case, one aims for a compromise between the size of the measuring signal and the sample weight to be employed.

For an AFR of 1, for example, a sample weight of 5 g per measuring period would be ideal. For another sample, which is likewise employed in a sample weight of 5 g but results in an AFR of 10, this means that the flow rate drops by 10% per measuring period. This is a relatively pronounced measuring effect, so that a sample weight of less than 5 g (per measuring period) would also suffice for a sufficient measuring effect.

The critical mass is a numerical value that indicates an upper limit for the amount of product to be applied in a trouble-free manner, using an original apparatus. A “critical mass” in an original apparatus can be extrapolated formally from the AFR value, using the surface ratio. The critical mass (CM) is calculated as follows:

$$\begin{matrix}CM [ g ] = Surface ratio / ( AFR [ \% / g ] / Inefficiency threshold [ \% ] ) \\ = Surface ratio * Inefficiency threshold [ \% ] / AFR [ \% / g ] .\end{matrix}$$

A specific factor that applies given the geometry of the arrangement according to the invention and the assumed conditions of an average field sprayer is assumed as surface ratio. For field sprayers that are substantially different, or when altering the filtering surface in the filter element, this factor must be adapted correspondingly.

The inefficiency threshold is the degree of covering of the filter at which visible signs of inefficiency are observed under realistic conditions and is normally in the range of from 80 to 100% of the filtering surface. When calculating the critical mass, it can simply be assumed that the degree of covering amounts to exactly 100%. An exception is when AFR is measured as 0%/g. In this case, CM can no longer be calculated, since the result of any division by zero is infinite. For practical purposes, however, this means that if an AFR of 0%/g, it is indeed possible to process any amount of product without covering the filter.

The device according to the invention contains an electrically operated pump, a flow meter, a sample charging receptacle, and a filter element. These units are connected to each other via a fluid circuit, the filter element being arranged downstream of the charging receptacle with respect to the direction of flow provided by the pump.

The fluid is preferably water but may also be a fertilizer solution used in agriculture or another fluid.

The charging receptacle has a circular cross-section, with a cylindrical upper part and a conical bottom part, and is provided with a tangential feed and a central drain for the fluid. In a measuring receptacle of this specific embodiment, the fluid rotates about a vertical axis. After the pump has started up, rotation is established automatically because of the specific geometry of the charging receptacle. During this process, a vortex develops in the middle of the charging receptacle, which should attain a depth of a few cm by setting a specific flow value. Due to this specific flow, the sample is first distributed uniformly in the water and then rapidly sucked into the filter element.

The charging receptacle can be jacketed so that cooling or heating fluid can circulate between the two walls of the charging receptacle for maintaining a specific temperature of the fluid located in the charging receptacle. The charging receptacle may also be equipped with an overflow so that, in case of a malfunction, the charging receptacle does not overflow in an uncontrolled fashion but the suspension can flow into the waste container provided.

The filter element is preferably made of transparent plastic so that the build-up of a coating on the filter can additionally be observed visually. The filter cloth preferably has a diameter in the range of from 2 to 20 mm (especially preferably in the range of from 5 to 10 mm) and the mesh size of the filter cloth is preferably in the range of from 50 to 1000 μm (especially preferably in the range of from 150 to 500 μm).

The device according to the invention may additionally contain a tank for the fluid, from which the charging receptacle can be charged with fluid, particularly when a particular quality of water or a fluid other than water is to be used. The tank can be equipped with one thermostat that maintains the temperature of the fluid in the tank in a temperature range of from 5 to 30° C.

The fluid circuit may be equipped with an outlet for draining the fluid.

The device according to the invention may contain a sample feed device equipped with a grab unit and one or more sample reservoirs in a storage device. The sample reservoirs are preferably disposable trays. The storage device is preferably a rack that can be shifted via a linear drive. The grab unit is preferably equipped with a gripper for gripping the sample reservoirs, a pneumatic cylinder to locate the sample reservoirs above the charging receptacle, and a rotary drive in order to empty the sample reservoirs above the measuring receptacle.

The device according to the invention may furthermore contain a cleaning device for the charging receptacle. Preferably, the cleaning device is equipped with a nozzle that can be moved in a linear fashion by means of a pneumatic cylinder and a valve for controlling the supply of the cleaning fluid.

In the device according to the invention, the dynamic disintegration of the samples on the way from the charging receptacle to the filter element takes place in a standardized manner. The sample is weighed into small tanks, from which it is poured rapidly and uniformly into the fluid in the charging receptacle. From the charging receptacle, the sample together with the fluid is sucked to the filter element with the aid of the pump. Those parts of the sample that have not disintegrated by then accumulate on the filter element. At this point in time, the flow rate drops and returns to its initial value only when all particles of the sample have eroded and then passed through the filter. Since the concentration is generally low and rarely exceeds 1%, the flow behavior of the suspension resembles that of the pure fluid (for example, water), so that after the samples have disintegrated completely, the flow rate usually returns to the initial 100% value and indeed sometimes slightly exceeds the initial value. The part of the suspension that passes through the filter element is recirculated into the charging receptacle via a pump and the flow meter. This is carried out until the predetermined measuring period has elapsed.

The processes that overlap during the dispersal of samples in fluids can be measured individually and independently of one another by the methods according to the invention.

The methods according to the invention are standardized tests that can be adapted flexibly to suit different realistic conditions by varying the adjustable parameters (water quality, water temperature, filter mesh size, and/or sample concentration in the fluid).

The descriptive test curves, which can easily be interpreted, permit direct conclusions regarding the causes for the shape of the curve so that any changes in the formula or in the preparation method of formulations can be arranged for if necessary. The single measurement is also suitable for addressing specific aspects before carrying out the measurement by preparing the sample in a suitable manner, for example, by subjecting it to a second drying step. Such factors bring about characteristic changes in the shape of the curve, which permit conclusions regarding the causes.

The good reproducibility of the readings and the high sensitivity permit the early identification of minute changes in the samples. This is advantageous for analyzing stored samples since findings on the behavior of the samples can be made at a very early stage, thereby saving development time.

The procedure of the methods according to the invention is very simple. Normally, sample preparation is limited to weighing. The result is obtained after a few minutes. Consequently, the methods according to the invention can be employed equally when tackling high sample numbers in the laboratory and as production control during manufacturing.

The build-up measurement identifies the possible presence of hard particles. Likewise, the build-up measurement provides information on the distribution of hard granules in the totality of the sample, that is to say, on sample homogeneity.

When carrying out the build-up measurement, the sensitivity can be increased by using smaller filtering surfaces.

The figures can be described as follows:

FIG. 1 Schematic shape of a test curve in a single measurement

FIG. 2 Schematic shape of a test curve in a build-up measurement

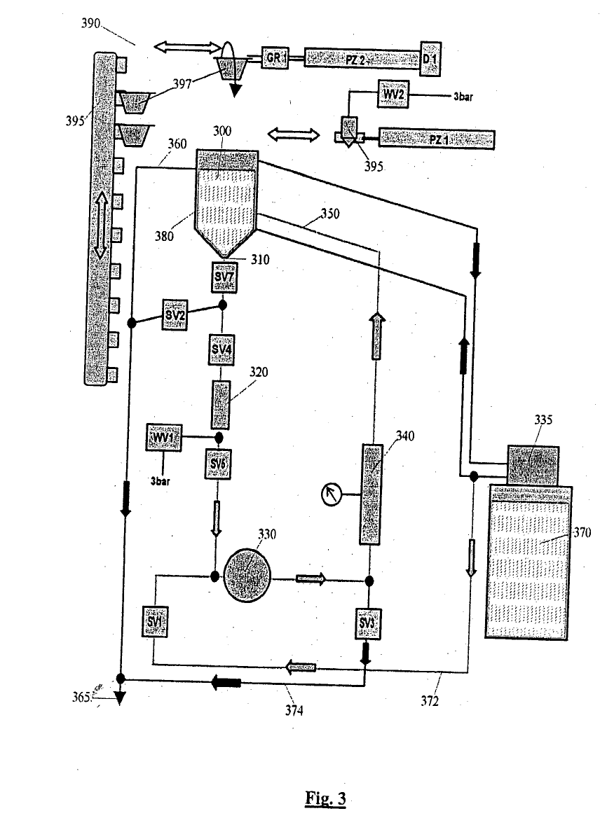

FIG. 3 Design example of the device according to the invention

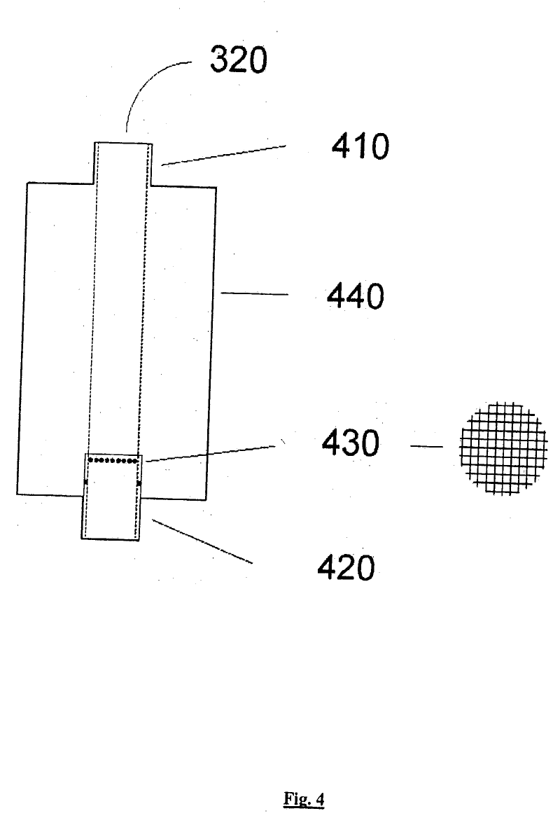

FIG. 4 Filter element

FIG. 5 Test curve of a single measurement on water-dispersible granules containing 70% by weight active ingredient (Granulat WG 70)

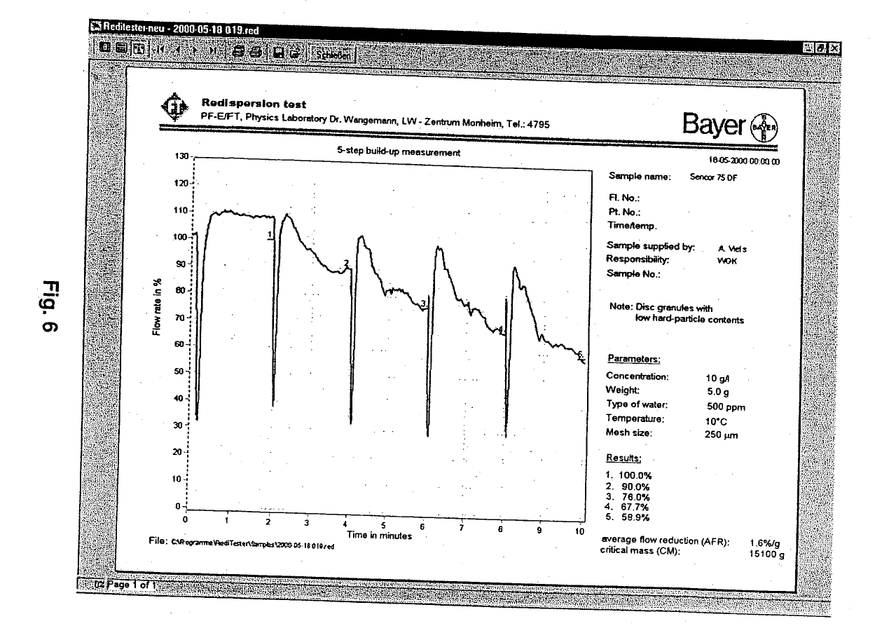

FIG. 6 Test curve of a 5-step build-up measurement

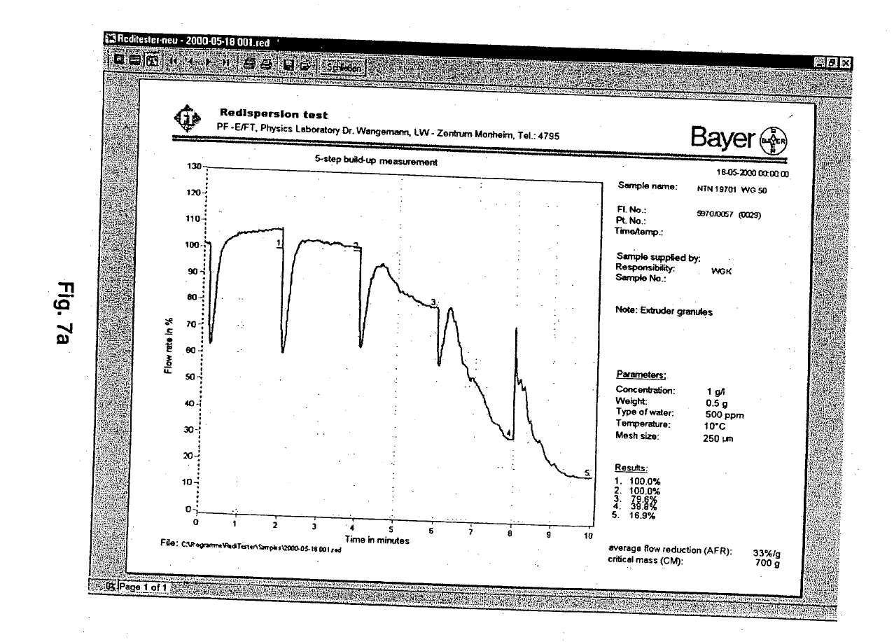

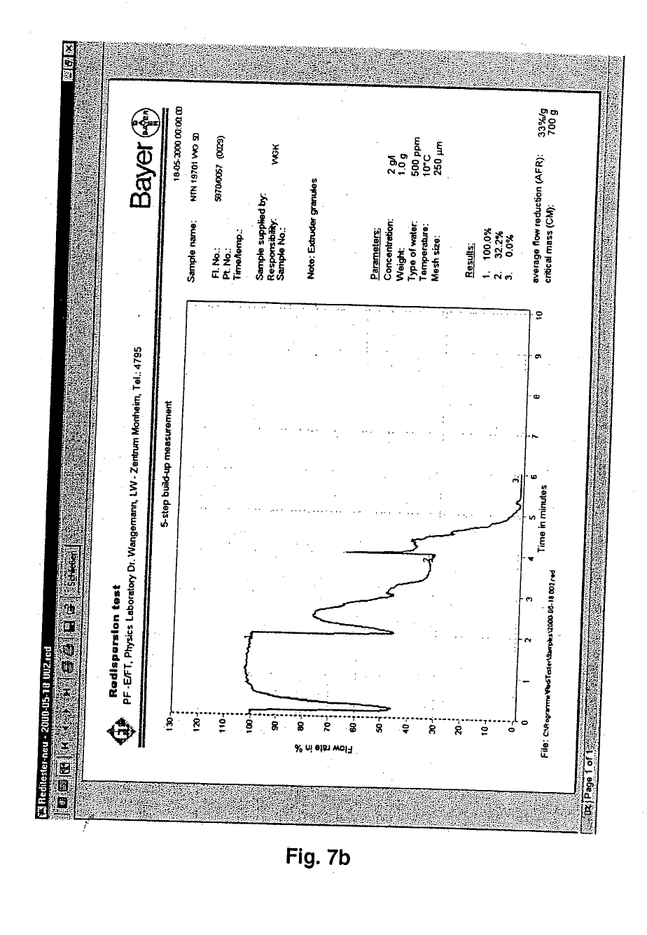

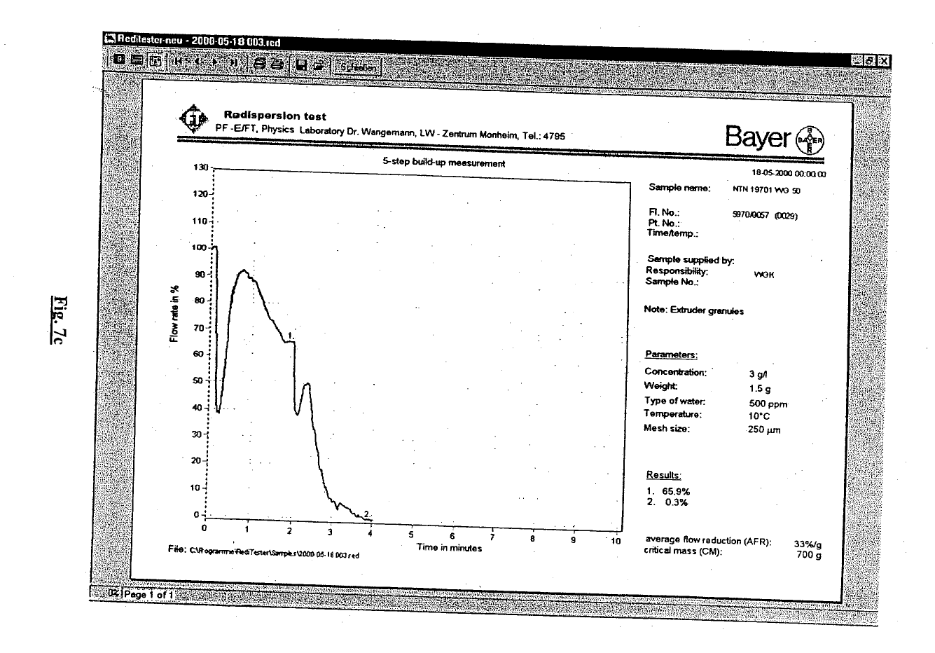

FIG. 7a Build-up measurement of a sample with a higher content of hard particles; sample weight 0.5 g (1 g/l) per period.

FIG. 7b Build-up measurement of a sample with a higher content of hard particles; sample weight 1 g (2 g/l) per period.

FIG. 7c Build-up measurement of a sample with a higher content of hard particles; sample weight 1.5 g (3 g/l) per period.

FIG. 8a Single measurement: sample 1, 500 μm filter.

FIG. 8b Build-up measurement: sample 1, 500 μm filter.

FIG. 8c Single measurement: sample 1, sample weight 1 g, 315 μm filter.

FIG. 8d Single measurement: sample 1, sample weight 1.5 g, 315 μm filter.

FIG. 8e Single measurement: sample 1, sample weight 2.5 g, 315 μm filter.

FIG. 9 Build-up measurement: sample 1, 4×0.5 g of sample (i.e., 2 g in total), 315 μm filter.

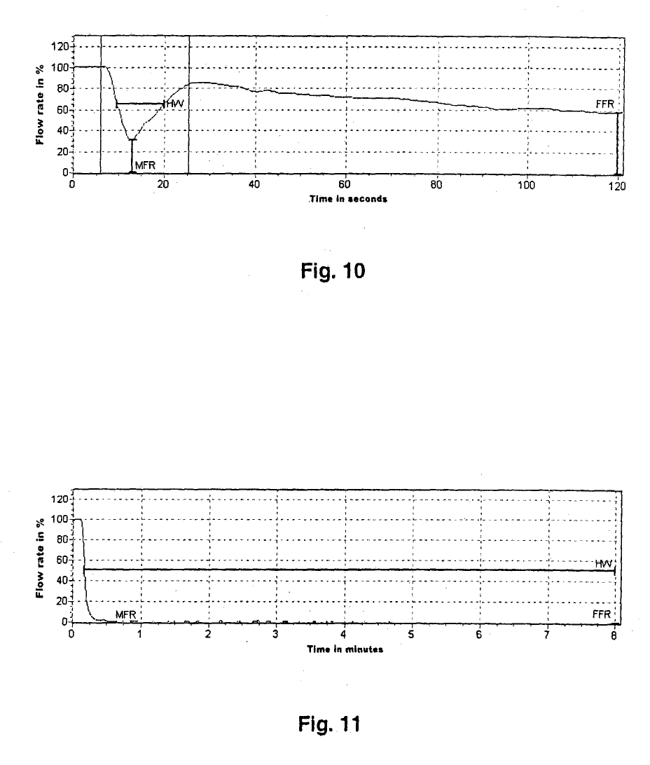

FIG. 10 Single measurement: sample 2.

FIG. 11 Single measurement: sample 3.

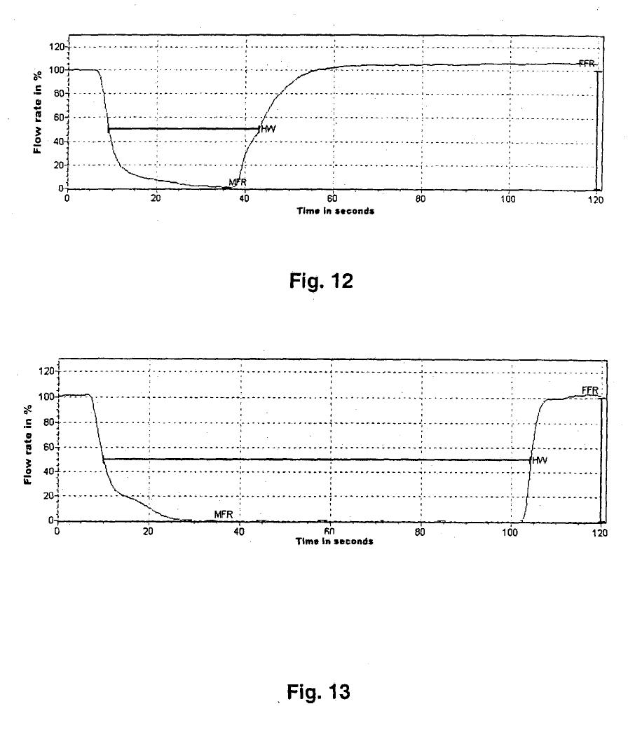

FIG. 12 Single measurement: sample 4, 20° C.

FIG. 13 Single measurement: sample 4, 10° C.

FIG. 1 schematically shows the shape of a test curve in a single measurement, whereas FIG. 2 schematically shows the shape of a test curve in a build-up measurement.

FIG. 3 shows a design example for the device according to the invention.

The measuring receptacle 300, the filter element 320, the pump 330, and the flow meter 340 are arranged in series in a water circuit. The water circuit additionally contains the valves SV7, SV4, and SV5. In the measuring state, water is circulated by the pump 330 in the direction of the arrows in FIG. 3.

The measuring receptacle 300 with a volume of around 0.5 liters is equipped with a downward drain 310 via the filter element 320 to the pump 330, as well as an upper return pass 350 and a lateral overflow 360, which is arranged slightly higher. The measuring receptacle 300 can be charged with preheated water from the tank 370 of the thermostat with the aid of the pump 335, the pipeline 372, and the valve SV1. The tank 370 maintains its own level or is filled up automatically. The twin-walled jacket 380 of the measuring receptacle 300, which is likewise traversed by water from the tank 370 of the thermostat, serves to maintain the temperature during measurement. Draining of the water from the water circuit can take place via the valve SV3 and the pipeline 374 into the waste 365.

The pump 330 is preferably an impeller pump and is operated electrically. Its characteristic is such that it delivers up to 2 liters per minute at maximum delivery (i.e., with filter 320 uncovered), generating a suction pressure of less than 0.1 bar, but reaches a maximum suction pressure of about 0.5 bar (but preferably only 0.2 bar) when the flow rate is zero (i.e., when the filter 320 is clogged). The narrowest cross-section in the circuit, namely the short tube of the flow meter 340 with its internal diameter of 2 to 3 mm (preferably 2.5 mm), has a decisive effect on the flow rate. The pump 330 is preferably operated in such a way that the desired flow rate at the beginning of the measurement is adjusted by altering the distribution voltage for the pump 330 to preferably between 0.6 and 1.4 liters per minute (especially preferably between 0.8 and 1.2 liters per minute). At such a flow rate, a small vortex of several cm in depth is generated in the water in the measuring receptacle 300 with tangential return pass 350, but this vortex is not deep enough for air to reach the filter element 320. During the measurement, the distribution voltage for the pump 330 is kept constant.

The flow meter 340, which operates by magneto-electric induction, measures the volume flow independently of the nature of the sample introduced. The measuring principle, which is known, requires only a low minimum conductivity of the suspension, which is virtually always the case since, first, the water already contains enough ions and thus has a certain conductivity and, second, since the granules contain components that increase conductivity. However, the reading does not depend on the magnitude of the conductivity as long as it exceeds a minimum value.

FIG. 4 is a schematic representation of a filter element 320 that can be employed in the device according to the invention. The body 440 of the filter element 320 consists of transparent plastic and is equipped with the two tube fittings 410 and 420 at its opposite ends. The cylindrical inner part of the filter element 320, with its specific geometry, plays a role in determining the readings. The filter cloth 430 is 7 mm in diameter. The internal diameter of the filter element is likewise 7 mm, whereas its length is 60 mm. The filter cloth is preferably employed in filter mesh sizes of 150, 250, 315, or 500 μm. The filter cloth and any material deposited thereon can be removed for visual or chemical analysis.

Sample delivery can be effected by means of a pneumatic grab unit 390 equipped with a gripper GR1, a rotary drive D1, and a pneumatic cylinder PZ2 (FIG. 3). The gripper GR1 pulls the disposable sample reservoirs 397 together with the samples in succession from a rack 395 with 10 delivery positions, positions them above the measuring receptacle 300 by the linear movement of the pneumatic cylinder P22, and empties them into the measuring receptacle 300 by rotation via the rotary drive D1. The emptied sample reservoirs 397 are returned to the rack 395. The rack 395 itself is shifted vertically by an electrical linear drive, whereby all 10 positions can be approached individually. Charging the rack 395 is done manually beforehand, as is weighing the samples into the small disposable sample reservoirs 397.

A computer controls all processes and transmits the control signals into the electromechanical/pneumatic part of the appliance with the aid of a modern data bus system. The computer is also used for processing and storing the data of the samples and the parameter values, choosing the variants of the measuring program, starting the measurement, and displaying the results on screen and paper.

All individual steps are controlled as a function of time and event; the process can be carried out by pneumatically actuated tube valves (SV1 through SV7) and water valves (WV1, WV2) as shown in FIG. 3.

In one embodiment of the invention, each measurement is automatically followed by a cleaning step using clean water. First, the suspension is drained by opening the valves SV7, SV2, SV4, SV5, and SV3 (FIG. 3). The inside of the measuring receptacle 300 is then rinsed using the spray nozzle 395, which can be positioned from another location into a location above the measuring receptacle 300 by means of the pneumatic cylinder PZ1. Then, SV2 and SV3 are closed and the measuring receptacle 300 is filled up to the top once, the water being circulated in the direction of the arrow by means of the pump 330. The amount of water exiting the spray nozzle 395 is controlled via the water valve WV2. Finally, SV2 and SV3 are reopened and the pump 330 is switched off so that the water can drain off.

Backwashing the filter 320 is a separate step in which water under pressure reaches the filter element via the valve WV1. To this end, WV1 is opened briefly while SV5 and SV7 remain closed and SV2 and SV4 are opened. In this way, the pressurized water can drain off via the lateral drain 365, removing the filter deposits in this process.

The following examples further illustrate details for the method of this invention. The invention, which is set forth in the foregoing disclosure, is not to be limited either in spirit or scope by these examples. Those skilled in the art will readily understand that known variations of the conditions of the following procedures can be used.

### EXAMPLES

The examples that follow provide an overview of frequently observed phenomena when carrying out measurements by the methods according to the invention.

Unless otherwise specified, all measurements of FIG. 5 to FIG. 13 were carried out with the following standard parameters:

| | |
|---|---|
| Concentration | 5 g/l |
| Type of water | 500 ppm |
| Temperature | 10° C. |
| Filter mesh size | 250 μm |

FIG. 5 shows an example of a test curve of a single measurement on granules termed WG 70, which comprise water-dispersible granules containing 70% by weight of the active compound MKH 6562 (also known as flucarbazone sodium). General information on the sample are listed next to the test curve, top right. The parameter values chosen for this measurement are stated on the right in the center:

| | |
|---|---|
| Concentration | 10 g/l |
| (Sample) weight | 5.0 g |
| Type of water | 500 ppm |
| Temperature | 10° C. |
| Filter mesh size | 250 μm |

The results obtained are listed on the right, bottom. In this single measurement, the following results were obtained: Peak depth, or minimum flow rate in % of the flow rate at the beginning of

the measuring period (MFR): 57%

Width at half-depth (HW): 16.0 s

Peak area (PA): 6.3% s/100

Flow rate at the end of the measuring period in % of the flow rate at the beginning of the measuring period (FFR): 100%. (The value, which is actually measured as above 100%, is set to 100%.)

Even though the voltage at the pump is kept constant during the measurement, a phenomenon, which could be misconstrued as a lack of consistency of the delivery, is occasionally observed. Depending on the composition of the sample, the test curve can, after the actual peak has subsided, occasionally rise to slightly above the original 100% value. This can be attributed to a slightly improved flowability or pumpability of the suspension in comparison with pure water. Such effects, which are known, are caused by adjuvants in the formulation (dispersants, emulsifiers, or polymers) but are immaterial for the dispersing process that is of actual interest. When evaluating the test curves, readings of above 100% are therefore set to 100%, and the characteristics are calculated accordingly (see “FFR” in FIG. 5).

FIG. 6 shows an example of a 5-step build-up measurement with a relatively large sample weight (sample weight 5 g per measuring period, corresponding to a concentration of 10 g/l). The steps identified by FIGS. 1 to 5 are not exactly the same height since the hard particles are not quite homogeneously distributed in the sample. This shows a further peculiarity: in measuring period 1, the few hard particles of the first sample portion are insufficient for measurably reducing the flow rate, so that no measured effect is observed in the first period. This can be explained by the fact that the flow rate is essentially determined by the narrowest point in the system (which is the flow meter in the preferred geometric design) since the filter cloth is larger in terms of surface area and the degree to Which it is covered is minor to start with. Only when the filter is covered to a higher degree, which is usually the case with only the second portion of the sample, will the steps, or measured effects, that establish themselves over the following periods be approximately equal in size.

With reference to a sample referred to as WG 50 (i.e., water-dispersible granules containing 50% by weight active ingredient), which is extruder granules with a higher hard-particle content (AFR is 33%/g), FIGS. 7a to 7c show the shape of the test curves of the build-up measurement with different sample weights. Here, it is unavoidable that the concentration of the suspension is different in each case. However, this fact is usually immaterial when carrying out a build-up measurement.

Each of FIGS. 7a, 7b, and 7c shows a series of 5 steps with sample weights of 0.5 g (1 g/l), 1 g (2 g/l), and 1.5 g (3 g/l), respectively, per measuring period. As expected, the larger the sample weight, the larger the steps caused by hard particles. The calculation of the average flow reduction (AFR) can be demonstrated most easily with reference to FIG. 7b (1 g, 2 g/l). The flow rate drops from 100% to 0% in three steps (referred to as 1, 2, and 3 in the curve), that is to say, on average by 33%. The AFR is then simply calculated from this average of 33%, divided by the sample weight in grams (in this case 1 g). In the two measurements shown in FIGS. 7a and 7c, smaller or larger steps are found correspondingly in more or fewer periods, respectively, from which the same AFR value of 33%/g is calculated.

The example demonstrates that the hypothesis of the AFR value depending on the weight employed is confirmed by the measurement. According to the above formula for calculating CM:

CM [g]=surface ratio/(AFR[%/g]/inefficiency threshold [%])

where the surface ratio is 250; AFR is 33%/g; and the inefficiency threshold is 100%,

a CM of 250/(33%/g/100%) of 757 results.

A value calculated thus will be rounded down to the nearest 100, in this case 700, simply for reasons of expediency and simplification. This is shown in FIGS. 7a, 7b, and 7c.

In the following examples of test curves, the key and the frame was omitted for simplicity, and only the actual shape of the curve is shown in a coordinate system in which the x-axis is time and the y-axis the % value (i.e., a reading).

FIG. 8a shows the shape of a curve for a single measurement of a sample that is hereinbelow referred to as sample 1. The test curve of the single measurement of sample 1 reveals no peak (MFR=100%). That is, the sample disintegrates very rapidly and apparently completely. The specific parameters chosen were sample weight 2.5 g using a 500 μm filter. The result is MFR=100% and FFR=100%.

As expected, a build-up measurement (FIG. 8b) on the same sample and in total twice the sample weight (5 g) reveals no filter deposit (AFR=0). The specific parameters chosen were 5×1 g of sample (5 g in total) using a 500 μm filter.

The shape of the curve changes markedly when the filter mesh size is reduced in a single measurement to 315 μm, using the same sample as in FIGS. 8a and 8b. FIGS. 8c, 8d, and 8e show single measurements with 1, 1.5, and 2.5 g of sample at the lower filter mesh size of 315 μm. In all cases, the flow rate is reduced, the more so the greater the sample weight. During the measuring period—in this case up to 8 minutes—the flow rate drops initially and then remains constant. Such curves are typical of samples with a hard-particle content.

The test curve in FIG. 8c shows a single measurement on sample 1 with a sample weight of 1 g. The result is FFR=77%.

The test curve in FIG. 8d shows a single measurement on sample 1 with a sample weight of 1.5 g. The result is FFR=32%.

The test curve in FIG. 8e shows a single measurement on sample 1 with a sample weight of 2.5 g. The result is FFR=3%.

The measurement in FIG. 8e can be compared directly with FIG. 8a in all parameters except for the filter mesh size. A comparison of these measurements leads to the conclusion that sample 1 contains hard particles that are capable of passing through a 500 μm filter but not through a 315 μm filter. Thus, sample 1 exemplifies changes in parameters that can lead to changes in test results.

This is even more obvious from a build-up measurement with the same sample as in FIGS. 8a to 8e using a 315 μm filter (FIG. 9). In measuring period 4, i.e., after 4×0.5 g (=2 g) of sample have passed through the filter, the flow rate drops to 0%. This drop is almost proportional to the sample weight. The result is AFR=50.

FIG. 10 shows the curve in a single measurement on granules that are hereinbelow referred to as sample 2. The shape of the curve is typical of samples containing hard particles. The small peak corresponds to rapid granule disintegration and the “tail” is caused by hard particles. The vertical lines can be drawn by hand in the measuring program and delimit the evaluation zone for the peak. The results of this single measurement are MFR=32%, HW=11 s, PA=36% s/100, and FFR=59%.

FIG. 11 shows the curve of a single measurement on different granules, which are hereinbelow referred to as sample 3. It is the extreme shape of a curve provided by a sample with a high hard-particle content. The results of this single measurement are: MFR=0%, HW>100 s, PA>100% s/100, and FFR=0%. Since the hard particles have not disintegrated after as long as 8 minutes, this means extremely poor quality for realistic conditions.

FIGS. 12 and 13 show the curves of single measurements on granules that are hereinbelow referred to as sample 4. The sample weight was in each case 2.5 g. The difference between the two measurements is the water temperature.

A water temperature of 20° C. was set for the single measurement of FIG. 12. The results are MFR=0%, HW=34 s, and PA=32.8% s/100.

A water temperature of 10° C. was set for the single measurement of FIG. 13. The results are MFR=0%, HW=94.4 s, and PA=92.8% s/100.

Thus, the width at half-depth HW and the peak area PA at 10° C. is much larger than at 20° C. This means that, in this sample, the granules disintegrate more rapidly at higher temperatures than at lower temperatures.

What is claimed is:

1. A device for measuring the dispersibility of a sample in a fluid comprising a charging receptacle for the sample, a filter element, a pump, and a flow meter that are connected to each other via a fluid circuit, wherein the filter element is arranged downstream of the charging receptacle with respect to the direction of flow provided by the pump.

2. A device according to claim 1 wherein the charging receptacle has a circular cross-section with a cylindrical upper part and a conical bottom part and is provided with a tangential feed and a central drain for the fluid.

3. A device according to claim 1 wherein the charging receptacle is jacketed.

4. A device according to claim 3 wherein cooling fluid can circulate between two walls of the jacketed charging receptacle.

5. A device according to claim 1 wherein the charging receptacle is equipped with an overflow.

6. A device according to claim 1 wherein the body of the filter element is made from a transparent plastic.

7. A device according to claim 1 wherein the filter element comprises a filter cloth having a diameter in the range of from 2 to 20 mm.

8. A device according to claim 1 wherein the filter element comprises a filter cloth having a diameter in the range of from 5 to 10 mm.

9. A device according to claim 1 wherein the filter element comprises a filter cloth having a mesh size in the range of from 50 to 1000 μm.

10. A device according to claim 1 wherein the filter element comprises a filter cloth having a mesh size in the range of from 150 to 500 μm.

11. A device according to claim 1 additionally comprising a tank from which the charging receptacle can be charged with the fluid.

12. A device according to claim 1 wherein the tank is equipped with a thermostat that maintains the temperature of the fluid in the tank in a temperature range of from 5 to 30° C.

13. A device according to claim 1 wherein the fluid circuit is equipped with an outlet for draining the fluid.

14. A device according to claim 1 additionally comprising a sample feed device equipped with a grab unit and one or more sample reservoirs in a storage device.

15. A device according to claim 14 wherein the sample reservoirs are disposable trays.

16. A device according to claim 14 wherein the storage device is a rack that can be shifted via a linear drive.

17. A device according to claim 14 wherein the grab unit is equipped with a rotary drive, a pneumatic cylinder, and a gripper.

18. A device according to claim 1 additionally comprising a cleaning device for the measuring receptacle and the filter element.

19. A device according to claim 18 wherein the cleaning device is equipped with a nozzle that can be moved in a linear fashion by means of a pneumatic cylinder and a water valve for controlling the supply of the cleaning fluid.

20. A device according to claim 1 equipped with pneumatically controlled valves for regulating the flow of the fluid through the fluid circuit and a drain for the fluid circuit.

21. A device according to claim 1 controlled by a computer that controls electromechanical, pneumatic, and hydraulic components of the device, stores the sample data and the parameter values, records the test curve, calculates the characteristics, and can display the results on a display unit.

22. A device according to claim 1 wherein the samples to be measured are solids.

23. A device according to claim 1 wherein the samples to be measured are in the form of granules.

24. A device according to claim 1 wherein the fluid is water.

25. A method for measuring the course of the dispersibility of a sample in a fluid over time comprising
(a) circulating the fluid through a sample charging receptacle, a filter element that is arranged downstream of the charging receptacle with respect to the direction of flow determined by the pump, and a flow meter,
(b) measuring the flow through the flow meter in the course of time during and after the charging receptacle is being or has been charged with the sample, and
(c) evaluating characteristic features of the flow rate vs. time.

26. A method according to claim 25 wherein the filter element is cleaned after each test curve has been recorded.

27. A method according to claim 25 wherein the sample is a solid.

28. A method according to claim 25 wherein the sample is in the form of granules.

29. A method according to claim 25 wherein the fluid is water.

30. A method according to claim 25 wherein test curves are recorded for various mesh sizes of the filter element, fluid temperatures, and/or sample concentrations.

31. A method according to claim 30 wherein the mesh size of the filter element is in the range of from 50 to 1000 μm.

32. A method according to claim 30 wherein the mesh size of the filter element is in the range of from 150 to 500 μm.

33. A method according to claim 30 wherein the fluid temperature is in the range of from 5 to 30° C.

34. A method according to claim 30 wherein the sample concentration is in the range of from 0.05% to 5%.

35. A method according to claim 30 wherein the sample concentration is in the range of from 0.1% to 1%.

36. A method according to claim 25 wherein the fluid is water and the water hardness is in the range of from 342 to 500 ppm.

37. A method according to claim 25 wherein the characteristic features comprise the depth, width, and/or area of a peak in the flow rate test curve and/or the deviation of the flow rate after the peak from the flow rate before the peak.

38. A method for detecting hard particles in a dispersion comprising
(a) circulating a fluid through a sample charging receptacle, a filter element that is arranged downstream of the charging receptacle with respect to the direction of flow determined by the pump, and a flow meter,
(b) measuring the flow through the flow meter over a predetermined period of time during and after a sample is being or has been charged to the charging receptacle,
(c) drawing of the suspension from the circulation and feeding in fresh fluid, without removing any deposit that may be present on the filter,
(d) repeating steps (b) and (c) one or more times with more of the same samples, and
(e) evaluating characteristic features of the flow rate vs. time plot.

39. A method according to claim 38 wherein the filter element is cleaned after step (e).

40. A method according to claim 38 wherein the sample is a solid.

41. A method according to claim 38 wherein the sample is in the form of granules.

42. A method according to claim 38 wherein the fluid is water.

43. A method according to claim 38 wherein test curves are recorded for various mesh sizes of the filter element, fluid temperatures, and/or sample concentrations.

44. A method according to claim 43 wherein the mesh size of the filter element is in the range of from 50 to 1000 μm.

45. A method according to claim 43 wherein the mesh size of the filter element is in the range of from 150 to 500 μm.

46. A method according to claim 43 wherein the fluid temperature is in the range of from 5 to 30° C.

47. A method according to claim 43 wherein the sample concentration is in the range of from 0.05% to 5%.

48. A method according to claim 43 wherein the sample concentration is in the range of from 0.1% to 1%.

49. A method according to claim 38 wherein the fluid is water and the water hardness is in the range of from 342 to 500 ppm.

50. A method according to claim 38 wherein steps (b) and (c) are repeated up to twenty times.

51. A method according to claim 38 wherein steps (b) and (c) are repeated five to ten times.

52. A method according to claim 38 wherein the predetermined measuring time per sample is 0.5 to 5 minutes.

53. A method according to claim 38 wherein the predetermined measuring time per sample is 1 minute to 3 minutes.

54. A method according to claim 38 wherein the characteristic feature comprises the deviation of the flow rate after the last measurement period from the flow rate at the beginning of the first measuring period.

55. A method according to claim 38 wherein the characteristic feature comprises the drop of the flow rate at the end of each measuring period.

56. A method according to claim 55 wherein the average flow reduction AFR is determined from the drop of the flow rate at the end of each measuring period using the formula:
$$AFR = \frac{\begin{matrix}Mean of the differences in flow \\ reduction per measuring period [ \% ]\end{matrix}}{Sample weight [ g ]} [ \% / g ] .$$

57. A method according to claim 56 wherein the critical mass CM is determined from the average flow reduction AFR using the formula:
CM [g]=surface ratio*inefficiency threshold [%]/AFR[%/g].

58. A method in which the method according to claim 25 and the method according to claim 38 are carried out in succession using portions of the same sample.
